(19) United States
(12) Patent Application Publication
(10) Pub. No.: US 2023/0311021 A1
(43) Pub. Date: Oct. 5, 2023

(54) COMBINED CLEANING AND STIRRING DEVICE FOR DISTILLATION STILL

(71) Applicant: Société JAS HENNESSY ET COMPAGNIE, Cognac (FR)

(72) Inventors: Félix POUYANNE-LAFUSTE, Cognac (FR); Jérôme ACKER, Merpins (FR); Moulay TAHIRI, Merpins (FR)

(73) Assignee: Société JAS HENNESSY ET COMPAGNIE, Cognac (FR)

(21) Appl. No.: 18/017,818

(22) PCT Filed: Jul. 23, 2021
(86) PCT No.: PCT/FR2021/051385

§ 371 Date: Jan. 24, 2023

(30) Foreign Application Priority Data
Jul. 24, 2020 (FR) 20 07850

(51) Int. Cl. B01D 3/02; B01D 1/22; B01F 35/10

(52) U.S. Cl. CPC B01D 3/02; B01D 1/223; B01F 35/1453

(57) ABSTRACT

A combined cleaning and stirring device for a distillation still comprises at least one hollow tube provided with at least one nozzle. The tube is adapted to place the at least one nozzle in fluid communication with a source of cleaning fluid, at least one stirring blade being fixed on said tube.

### TECHNICAL FIELD

This description relates to a combined tank cleaning and stirring device for the food industry. This description relates in particular to a combined device for cleaning and stirring a distillation still, more particularly a distillation still intended for the production of eaux de vie. This description also relates to a tank system, in particular to a distillation still system, comprising such a combined cleaning and stirring device.

### PRIOR ART

It is known to make an eau de vie by distilling wines, sometimes accompanied by their lees. Lees are defined as the dead cells of the yeasts used for alcoholic fermentation of the musts, and the compact solids resulting from harvest and vinification. This distillation is traditionally carried out in a still.

However, this type of distillation presents a certain number of risks, for the quality of the eau de vie produced and for the still. This is because solids from the lees can settle and cling (in French “rimer”) to the bottom of the still. The quality of the eau de vie produced is therefore greatly altered. The eau de vie is then difficult to market. Furthermore, the still may be damaged, which can require the intervention of a boilermaker to repair it. The risk of such deposits is particularly high between the moment the wines are loaded into the still and when they come to a boil. In general, this corresponds to a timeframe of about ninety minutes.

An example of a known still system 100 is shown in FIG. 1. Such a system 100 comprises a still 102, provided with a cleaning device 104 inside still 102. Cleaning device 104 is generally formed of a plurality of nozzles 106, in fluid communication with a source of cleaning liquid, via a hollow tube 108, connected to a supply system 110 for supplying cleaning device 104 with cleaning liquid. Still 102 is generally rotationally symmetrical. Tube 108 can form a closed curve as shown in FIG. 1.

As illustrated by arrow F1, tube 108 is mounted so that it can rotate in relation to still 102, around a central axis X of still 102 equipped with cleaning device 104. In the case shown here the axis of rotation of tube 108 corresponds to the axis of symmetry of still 102. Tube 108 here is fixed to a bearing 112, allowing rotation around axis X of tube 108. Advantageously, nozzles 108 are arranged on tube 108 such that the pressurized supply of cleaning fluid from nozzles 106 causes tube 110 to rotate in one direction of rotation. The cleaning fluid is, for example, water or still wash.

As can be seen in FIG. 1, cleaning device 104 is relatively cumbersome in still 102. It is however recognized as particularly effective.

Due to the bulk of cleaning device 104, it appears difficult to place a stirring system in still 102, in order to limit or even avoid the deposit of solids at the bottom of the still.

### SUMMARY OF THE INVENTION

More generally, there is a need for a tank, intended in particular for use in the food industry, in which the contents can be stirred while also accommodating a device for cleaning the inside of the tank.

To this end, a combined tank cleaning and stirring device is described for the food industry, in particular for distillation stills, comprising at least one hollow tube provided with at least one nozzle, the tube being suitable for placing the at least one nozzle in fluid communication with a source of cleaning fluid, at least one stirring blade being affixed to said tube.

Thus, advantageously, the tube traditionally implemented in a tank cleaning device is used as a support for at least one stirring blade. It is thus possible to design a combined device for cleaning the tank and stirring the contents of the tank, despite the significant bulk of the elements required for cleaning.

According to preferred embodiments, the combined tank cleaning and stirring device for the food industry has one or more of the following features, alone or in combination:
the at least one tube forms a closed curve;
the at least one tube forms a curved stirrup shape, with two spaced-apart parallel portions connected by two curved branches, an inlet for cleaning fluid preferably being provided substantially at the center of one of the two space-apart parallel portions;
the combined tank cleaning and stirring device for the food industry comprises a plurality of nozzles, preferably between 10 and 100 nozzles;
the combined tank cleaning and stirring device for the food industry comprises a plurality of stirring blades, at least one stirring blade being arranged between two successive nozzles;
the combined tank cleaning and stirring device for the food industry further comprises a drive motor for rotating the at least one tube and, preferably, a reduction gear system between the motor and the at least one tube;
the combined tank cleaning and stirring device for the food industry further comprises a clutch between the drive motor and the at least one tube;
the motor and/or the reduction gear system is/are adapted such that the motor is capable of rotating the tube in two opposing directions;
the at least one stirring blade is retractable, in particular depending on the direction of rotation of the tube;
the at least one stirring blade is mounted to pivot on the tube, the at least one stirring blade being adapted to come to rest against a first abutment when the tube rotates in a first direction and, preferably, against a second abutment when the tube rotates in a second direction; and
the at least one blade comprises a main portion that is substantially flat, from which at least one fin extends at an angle from a side or bottom end.

According to another aspect, a tank system is described, in particular a distillation still, comprising a tank, preferably a still, and a combined cleaning and stirring device according to any one of the preceding claims, the at least one tube being inside the tank.

The tank system may further comprise a means for heating the contents of the tank, in particular a burner.

The tank system may comprise an electronic control unit suitable for synchronously controlling the tube's direction of rotation and/or the clutch, if any, on the one hand, and, on the other hand, at least one of: the means for heating the contents of the tank and a valve for placing said at least one nozzle in fluid communication with a source of pressurized cleaning liquid.

### BRIEF DESCRIPTION OF DRAWINGS

The invention will be better understood from the description which follows, made with reference to the attached drawings, among which:

FIG. 1 schematically shows a known still system comprising a cleaning device, in longitudinal cross-section;

FIG. 2 is a view similar to FIG. 1, of another example of a still system;

FIG. 3 schematically illustrates a first variant of the combined cleaning and stirring device that can be implemented in the still system of FIG. 2;

FIG. 4 schematically illustrates a second variant of the combined cleaning and stirring device that can be implemented in the still system of FIG. 2; and

FIG. 5 is a partial cut-away view of a second example of a still system.

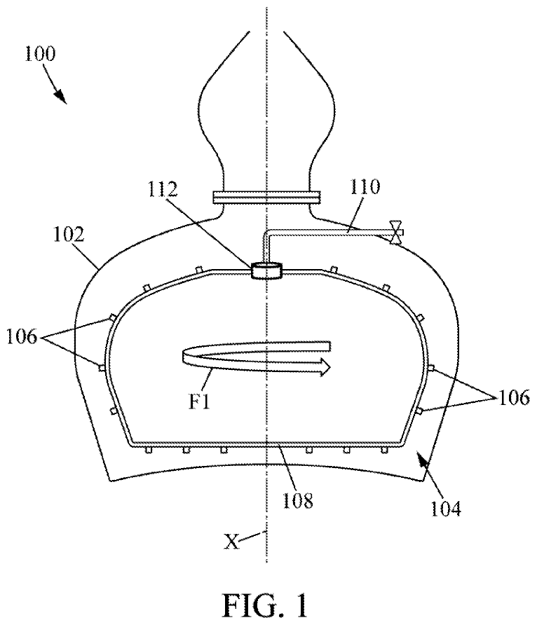

### DESCRIPTION OF EMBODIMENTS

In the rest of the description, identical elements or identical functions bear the same reference numbers. In the interest of keeping this description concise, these elements are not described within the framework of each embodiment. Instead, only the differences between embodiments are described.

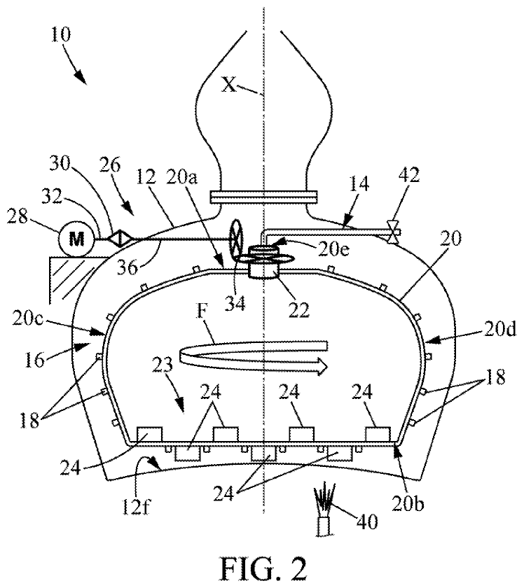

FIG. 2 illustrates a still system 10. Still system 10 firstly comprises a still 12, a combined cleaning and stirring device 16, and a pressurized cleaning liquid supply system 14 for combined cleaning and stirring device 16. The cleaning liquid may in particular be still wash or water. Still 12 is for example rotationally symmetrical about axis X. Bottom 12f of the still is advantageously convex, to limit deposits at the center of still 12.

Combined device 16 for cleaning still 12 and stirring the contents of still 12 is designed to be inside the still 12 itself. Combined cleaning and stirring device 16 firstly comprises a plurality of nozzles 18, in fluid communication with a source of liquid via a hollow tube 20, connected to cleaning liquid supply system 14 for the device for cleaning still 12. The number of nozzles 18 may be for example between 10 and 100 nozzles. The number of nozzles 18 may be chosen according to the capacity of still 12 and/or the flow rate of cleaning liquid supplying combined cleaning and stirring device 16. Each of nozzles 18 may be oriented towards the nearest wall of still 12. Tube 20 forms a closed curve. In other words, tube 20 forms a loop. Tube 20 here has the shape of a stirrup. In other words, tube 20 has two spaced-apart portions 20a, 20b which are substantially parallel, joined by two curved branches 20c, 20d which are symmetrical along the midplane of tube 20, perpendicular to the plane of FIG. 2. The midplane of tube 20 includes the axis X of rotation of tube 16 and the axis of symmetry of still 12. A cleaning fluid inlet 20e is provided here substantially at the center of one of the two spaced-apart parallel portions 20a, 20b.

As illustrated by arrow F, tube 20 is mounted so that it can rotate in relation to still 12, around central axis X of combined cleaning and stirring device 16 and of still 12. To do this, tube 20 is fixed to a bearing 22, allowing rotation around axis X of rotation of tube 20. Advantageously, at least some nozzles 18 are arranged on tube 20 such that the supply of pressurized cleaning fluid from nozzles 18 cause the rotation of tube 20. For example, tube 20, having a plane of symmetry (perpendicular to the plane of FIG. 2 and passing through axis X), can be divided into two lateral halves. Nozzles 18 are arranged on one side of tube 20 on one lateral half of tube 20, and nozzles 18 are arranged on the other side of tube 20 on a second lateral half of tube 20. For example, in FIG. 2, a plurality of nozzles 18 are located on the back side of tube 20, on the left lateral half of tube 20, and another plurality of nozzles 18 are located on the front side of tube 20, on the right lateral half of tube 20. Thus, the expulsion of fluid by nozzles 18 creates a torque on tube 20 which causes it to rotate around axis X. Advantageously, additional nozzles 18 are arranged so as to minimize the torque created when fluid is expelled by the other nozzles 18. To do this, these additional nozzles 18 may for example be arranged on the outer side of tube 20, and be oriented substantially along the plane of FIG. 2.

Furthermore, the combined cleaning and stirring device 16 comprises stirring means 23 for stirring the fluid contained in the still.

These stirring means 23 first of all comprise tube 20, in that it bears one or more stirring blades 24. Advantageously, the stirring blade or blades 24 are fixed to a portion of hollow tube 20 near the bottom of still 12, where the risk of deposits is greatest. Here, for example, stirring blades 24 are fixed on one of the two spaced apart and substantially parallel portions 20a, 20b, more precisely on portion 20b of two portions 20a, 20b of tube 20, the one closest to the bottom of still 12.

In the example of FIG. 2, portion 20b of tube 20 is provided with seven stirring blades 24 which advantageously extend on either side of the plane of FIG. 2. Each stirring blade 24 may extend at an angle in order to follow the convexity of bottom 12f of the still when tube 20 rotates in the direction of arrow F. Nozzles 18 may be placed between stirring blades 24. In this case, it is preferred that stirring blades 24 do not interfere with the jet from nozzles 18, while being close enough to bottom 12f of the still to create an upward movement of the particles in suspension in the wine being distilled. Stirring blades 24 can be oriented vertically or at an angle to the horizontal direction. Stirring blades 24 can in particular be arranged on the upper part or on the lower part of lower portion 20b of tube 20.

The height of stirring blades 24, measured in the direction of axis X, can in particular be equal to or even substantially greater than the height of nozzles 18, also measured in the direction of axis X. For example, the height of stirring blades 24 is between 2 and 3 cm.

The stirring means also comprise a drive system 26 for rotating hollow tube 20 around its axis X of rotation. According to the example of FIG. 2, drive system 26 comprises a drive motor 28 and a reduction gear system 30 between output shaft 32 of drive motor 28 and hollow tube 20.

Additionally, in the example of FIG. 2, there is provided a clutch 34 between output shaft 32 of drive motor 28 and hollow tube 20. Clutch 34 may for example be positioned between output shaft 32 of the motor and reduction gear system 30 or, as shown in FIG. 2, between output shaft 36 of reduction gear system 30 and hollow tube 20.

Indeed, in this first exemplary embodiment, rotation of hollow tube 20 by drive motor 28 is in principle only necessary when device 16 is utilized to stir the liquid contained in still 12. On the contrary, when device 16 is used to clean the inside of still 12, the pressure of the cleaning liquid and the positioning of nozzles 18 can allow rotating tube 20 without requiring the utilization of drive motor 28. In this case, it is preferable to disengage clutch 34, so that drive motor 28 does not hinder by this rotation of tube 20.

Thus, advantageously, combined cleaning and stirring device 16 makes it possible to provide a stirring device inside still 12, despite the large bulk of tube 20 which is necessary for an efficient cleaning system.

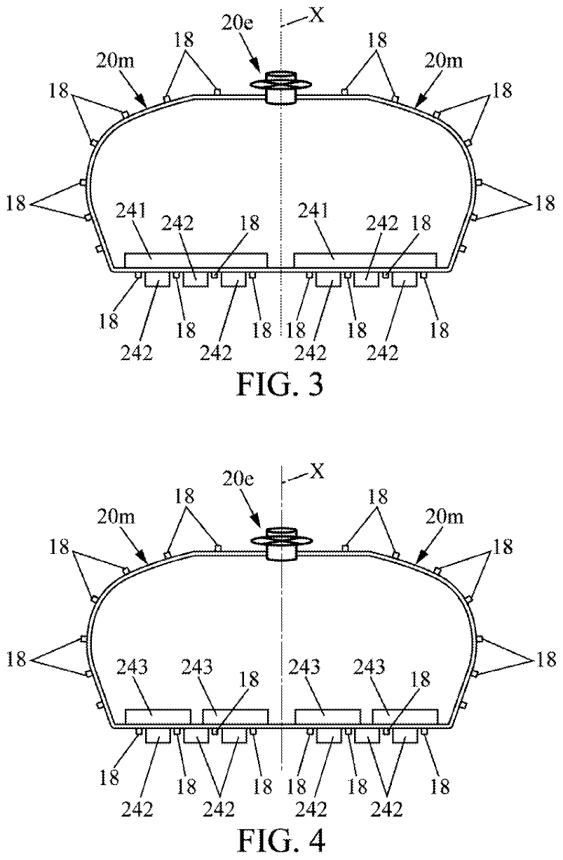

FIGS. 3 and 4 illustrate two variants of the system of FIG. 2, which differ essentially in the number and position of stirring blades 24 and in the number and position of nozzles 18.

Thus, in FIG. 3, each lateral half 20m of tube 10 is equipped with stirring blades 24. A first stirring blade 241 extends from the side of tube 20 that is opposite to bottom 12f of still 12. “Opposite” is defined here as the side of tube 20 which is oriented substantially in the same direction as bottom 12f of still 12, as opposed to the side of tube 20 which is facing bottom 12f of still 12. This side of tube 20, facing the bottom of still 12, is, according to FIG. 3, provided with four nozzles 18 per half 20m of tube 20. According to the example of FIG. 3, a stirring blade 242 is placed between two successive nozzles 18. Three stirring blades 24 are thus placed on portion 20b of tube 20, per lateral half 20m of tube 20. Such an embodiment makes it possible to prevent stirring blades 24 from interfering with the jet of cleaning liquid emitted by nozzles 18 when device 16 is used to clean the interior of still 12. The height of stirring blades 241, 242 may also be between 2 and 3 cm.

The example shown in FIG. 4 essentially differs from that of FIG. 3 in that two stirring blades 243 are arranged on the surface of portion 20b which is opposite to bottom 12f of the still, per lateral half 20m of tube 20. The length of each stirring blade 243 is in this case substantially less than a quarter of the length of portion 20b of tube 20. A slight space is thus maintained between two stirring blades 243. Such an embodiment makes it possible to reduce the force of the resistance to the rotation of tube 20 caused by stirring blades 24, while maintaining a high stirring power in the combined cleaning and stirring device 16.

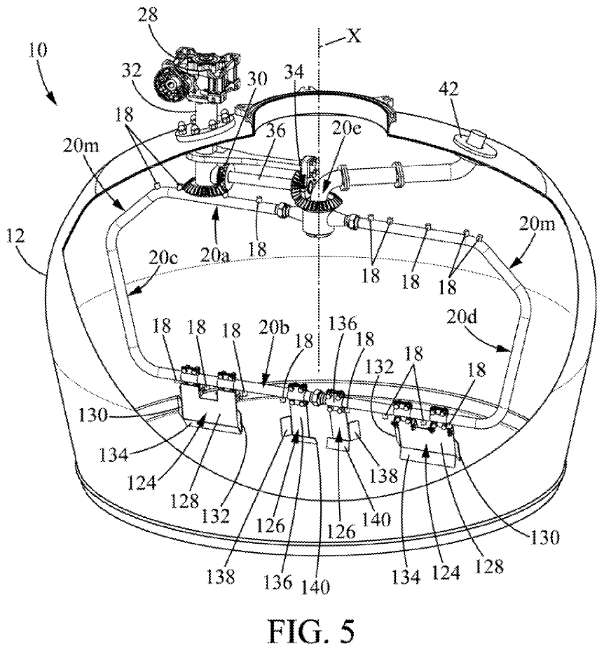

FIG. 5 illustrates a second example of still system 10. This differs from the first example of a still described in FIGS. 2 to 4, essentially in the arrangement of motor 28 and in the shape and position of stirring blades 124, 126.

Thus, in the example shown in FIG. 5, motor 28 is arranged so that output shaft 32 extends substantially parallel to axis X of rotation of tube 20. It is thus possible to achieve a substantially more compact configuration of still system 10. To achieve this, reduction gear system 30 may for example comprise bevel gears.

Furthermore, here there are four stirring blades 124, 126: two wider blades 124 are arranged substantially halfway between the lateral ends of portion 20b of tube 20 and the middle of portion 20b of tube 20, while two less wide blades 126 are arranged substantially on either side of the middle of portion 20b of tube 20, between the middle of portion 20b and blades 124.

Stirring blades 124 have a substantially flat main portion 128, here extending outward from the plane of extension of tube 20. Main portion 128 is U-shaped, a nozzle 18 outlet being between the two sides of the U. Additionally, stirring blades 124 comprise a first fin 130 extending at an angle from the radially outer end of main portion 128 of stirring blade 124. First fin 130 here extends rearwards in relation to the direction of rotation of tube 20 when being operated for stirring. Stirring blades 124 further comprise a second fin 132 extending at an angle from the radially inner end of main portion 128 of stirring blade 124. Second fin 132 here extends forwards in relation to the direction of rotation of tube 20 when being operated for stirring. Finally, a third fin 134 extends at an angle from the bottom end of main portion 128 of each stirring blade 124. In the example illustrated, third fin 134 is oriented in the same direction as first fin 130. In other words, third fin 134 is oriented rearwards in relation to the direction of rotation of tube 20 when being operated for stirring.

Radially internal stirring blades 126 also comprise a main portion 136 that is substantially flat, here extending in the plane of extension of tube 20. Here, main portion 136 of stirring blades 126 is substantially rectangular. Furthermore, stirring blades 126 comprise a first fin 138 extending at an angle from the radially outer end of main portion 136 of stirring blade 126. First fin 138 here extends forwards, in the direction of rotation of tube 20 when being operated for stirring. Similarly, a second fin 140 extends at an angle from the lower end of main portion 136 of each blade 126. In the example illustrated, second fin 140 is oriented rearwards, in relation to the direction of rotation of tube 20 when being operated for stirring.

Fins 130, 132, 134, 138, 140 make it possible in particular to generate flows in the liquid during stirring, aimed at improving the quality of the stirring. However, the position and configuration of blades 124, 126, in particular of their fins 130, 132, 134, 138, 140, may of course be different, in particular depending on the characteristics desired for the stirring.

The invention is not limited to the examples which have just been described. On the contrary, many variants are accessible to those skilled in the art.

Firstly, it is possible to drive the rotation of tube 20 using motor 28 for both the cleaning and the stirring modes of combined device 16. For example, the motor can be controlled in one direction of rotation in one mode of operation, and in a second direction of rotation in a second mode of operation. Alternatively, the motor can rotate the tube via a first reduction gear system 30 in one mode of operation and via a second reduction gear system in a second mode of operation.

The fact of rotating tube 20 by means of a motor, even in cleaning mode, affords a wider choice of placements for nozzles 18. In particular, the position of nozzles 18 can be chosen to optimize cleaning, without worrying about the kinematics of tube 20 as this is ensured by motor 28. The position of nozzles 18 can then be chosen to be on one side and/or on the other side of tube 20. In particular, all nozzles 18 can be on the same side of tube 20.

In a variant not shown, it is also possible to provide retractable stirring blades 24. It is thus possible to retract stirring blades 24 when combined device 16 is utilized for cleaning the interior of still 12. In this case, for example, when utilizing the stirring function of combined device 16, all stirring blades 24 are deployed and extend between tube 20 and the wall of still 12. In contrast, when utilizing the cleaning function, stirring blades 24 all extend into the volume defined by tube 20 pivoting around axis X. Alternatively, the stirring blades may be pivoted so that, when retracted, they extend substantially within the plane defined by the movement of portion 20b of tube 20 when said tube rotates around axis X.

According to another example, the blades are pivotally mounted on tube 20, such that:
the rotation of tube 20 in one direction tends to pull the blades down into the plane of portion 20b of the tube, the blades coming to rest against a first abutment, preferably in the cleaning operating mode, while
the rotation of tube 20 in a second direction, opposite to the first, tends to push the blades into the plane of tube 20, the blades coming to rest against a second abutment, preferably in the stirring operating mode. According to yet another variant, only a portion of the blades is pivotally mounted, so that only this portion pivots in relation to a portion of the base of the blade, depending on the direction of rotation of the tube. In the case where the blades are retractable, the height of the deployed blades is preferably between 2 and 3 cm.

Other embodiments of retractable blades are accessible to those skilled in the art, which improve stirring when using stirring mode in comparison to cleaning mode, while limiting the mechanical stress on tube 20 during rotation while in the cleaning mode of operation and, preferably, not interfering with the jet of cleaning liquid from nozzles 18.

There may also be provided, for example, an electronic control unit to automate still system 12, controlling the coupling and startup of drive motor 28 for tube 20, so as to trigger the stirring synchronously with triggering a means for heating the contents of still 12, for example a burner 40. Similarly, the electronic unit can control clutch 34 to decouple drive motor 28 from hollow tube 20 at the end of stirring. This decoupling by means of the clutch, or the direction of rotation of tube 20, may in particular be controlled according to a setpoint temperature or a drop in pressure of the combustion gas for still 12. The electronic unit may further control the direction of rotation of tube 20 and/or of drive motor 28, depending on the mode of operation, stirring or cleaning.

The electronic control unit may further be suitable for synchronously controlling clutch 34 or the direction of rotation of tube 20, on the one hand, and, on the other hand, at least one of: the means for heating 40 and a valve 42 for placing nozzles 18 in fluid communication with a source of cleaning liquid.

Finally, the examples described above relate to the preferred case of a distillation still intended for the production of eau de vie. However, the teachings of this application relate more generally to any tank that can be utilized in the food industry, capable of receiving contents to be stirred and which can be cleaned quickly and efficiently by means of the combined cleaning and stirring device.

1. A combined cleaning and stirring device for a distillation still, comprising at least one hollow tube provided with at least one nozzle, the tube being suitable for placing the at least one nozzle in fluid communication with a source of cleaning fluid, at least one stirring blade being affixed to said tube.

2. The device according to claim 1, herein the at least one tube forms a closed curve.

3. The device according to claim 1, wherein the at least one tube forms a curved stirrup shape, with two spaced-apart parallel portions connected by two curved branches.

4. The device according to claim 1, comprising a plurality of nozzles.

5. The device according to claim 4, comprising a plurality of stirring blades, at least one stirring blade being arranged between two successive nozzles.

6. The device according to claim 1, further comprising a drive motor for rotating the at least one tube.

7. The device according to claim 6, further comprising a clutch between the drive motor and the at least one tube.

8. The device according to claim 6, wherein at least one among the motor and the reduction gear system adapted such that the motor is capable of rotating the tube in two opposing directions.

9. The device according to claim 1, wherein the at least one stirring blade is retractable.

10. The device according to claim 9, wherein the at least one stilling blade is mounted to pivot on the tube, the at least one stirring blade being adapted to come to rest against a first abutment when the tube rotates in a first direction.

11. The device according to claim 1, wherein the at least one blade comprises a main portion that is substantially flat, from which at least one fin extends at an angle from a side or bottom end.

12. A distillation still system, comprising a still and a combined cleaning and stirring device according to claim 1, the at least one tube being inside the still.

13. The distillation still system according to claim 12, further comprising means for heating the contents of the still, in particular a burner.

14. The distillation still system according to claim 13, comprising an electronic control unit suitable for synchronously controlling the direction of rotation of the tube, if any, on the one hand, and, on the other hand, at least one of among the means for heating the contents of the still and a valve for placing said at least one nozzle in fluid communication with a source of pressurized cleaning liquid.

15. The device according to claim 4, wherein an inlet for cleaning fluid is provided substantially at the center of one of the two spaced-apart parallel portions.

16. The device according to claim 14, wherein the at least one stirring blade is adapted to come to rest against a second abutment when the tube rotates in a second direction.

17. The device according to claim 5, comprising between 10 and 100 nozzles.

18. The device according to claim 8, further comprising a reduction gear system between the motor and the at least one tube.

19. The device according to claim 12, wherein the at least one stirring blade is retractable depending on the direction of rotation of the tube.

20. The device according to claim 14, wherein the at least one stirring blade is adapted to come to rest against a second abutment when the tube rotates in a second direction.

21. The device according to claim 1, wherein the at least one blade comprises a main portion that is substantially flat, from which at least one fin extends at an angle from a side or bottom end.

22. A distillation still system comprising a still and a combined cleaning and stirring device according to claim 1, the at least one tube being inside the still.

23. The distillation still system according to claim 17, further comprising means for heating the contents of the still.

24. The distillation still system according to claim 18, comprising an electronic control unit suitable for synchronously controlling the direction of rotation of the tube on the one hand, and, on the other hand, at least one of among the means for heating the contents of the still and a valve for placing said at least one nozzle in fluid communication with a source of pressurized cleaning liquid.

25. The distillation still system according to claim 18, wherein the combined cleaning and stirring device comprises a clutch between a drive motor and the at least one tube, and wherein the distillation still system comprises an electronic control unit suitable for synchronously controlling at least one among the direction of rotation of the tube and the clutch, on the one hand, and, on the other hand, at least one of among the means for heating the contents of the still and a valve for placing said at least one nozzle in fluid communication with a source of pressurized cleaning liquid.
